(19) United States
(12) Patent Application Publication
(10) Pub. No.: US 2010/0270470 A1
(43) Pub. Date: Oct. 28, 2010

(54) INFRARED RAY DETECTOR AND ELECTRICAL APPARATUS

(75) Inventors: Jun Sasaki, Yokosuka-Shi (JP); Noriyuki Kitamura, Hadano-Shi (JP); Yuji Takahashi, Sagamihara-Shi (JP); Takaya Kamakura, Yokosuka-Shi (JP)

Correspondence Address: DLA PIPER LLP US, P. O. BOX 2758, RESTON, VA, 20195, US

(73) Assignee: TOSHIBA LIGHTING & TECHNOLOGY CORPORATION, Yokosuka-Shi (JP)

(21) Appl. No.: 12/767,130

(22) Filed: Apr. 26, 2010

(30) Foreign Application Priority Data
Apr. 28, 2009 (JP) 2009-109869
Mar. 9, 2010 (JP) 2010-051898

(51) Int. Cl. G01J 5/08

(52) U.S. Cl. 250/353

(57) ABSTRACT

The present invention provides an infrared ray detector capable of facilitating design of a compound lens and capable of reliably detecting a heat source in a stabilized state, which is provided with a light receiving portion for detecting infrared ray energies, and a compound lens having a plurality of lens portions to condense an infrared ray in a predetermined detection area to the light receiving portion, wherein individual detection areas which condense infrared rays to the light receiving portion through the respective lens portions of the compound lens exist in the entire range of a predetermined detection area, and at least a part of the individual detection areas overlap each other.

### INCORPORATION BY REFERENCE

The present invention claims priority under 35 U.S.C. §119 to Japanese Patent Application Nos. 2009-109869 and 2010-051898 filed on Apr. 28, 2009 and Mar. 9, 2010, respectively. The contents of these applications are incorporated herein by reference in their entirety.

### FIELD

Embodiments described herein relate generally to an infrared ray detector for detecting a desired heat source and an electrical apparatus using the infrared ray detector.

### BACKGROUND

Conventionally, an infrared ray detector for detecting an infrared ray emitted from a human body has been used for a human body sensor to control a lighting instrument and alarm equipment by detecting a human body in a predetermined detection area.

In the infrared ray detector, a pyroelectric type infrared ray detection element has generally been used. Further, a compound lens having a plurality of lens portions has frequently been used in order to widen the detection area and to efficiently condense infrared rays to the pyroelectric type infrared ray detection element.

The pyroelectric type infrared ray detection element is a sensor utilizing a pyroelectric effect, in which one light receiving portion is composed of two or four light receiving electrodes as a set. Electric signals in response to a change in the amount of infrared rays in accordance with movement of a human body, which is condensed through respective lens portions of a compound lens, are output to the light receiving portion. Therefore, in the pyroelectric type infrared ray detection element, where there is no movement in a human body in a detection area or where the movement is very slight or slow, there is a drawback by which the human body cannot be detected.

Further, since a human body cannot be detected by a pyroelectric type infrared ray detection element for detecting a change in the amount of infrared rays in accordance with movement of a human body if individual detection areas, which detect infrared rays through respective lens portions in a compound lens, overlap each other, it is configured that the individual detection areas are dispersed and distributed in an entire detection area in a state where the individual detection areas are apart from each other as described in, for example, Japanese Laid-Open Patent Publication No. 9-230060.

However, in the conventional infrared ray detector, since a pyroelectric type infrared ray detection element is used, it is necessary that, in the compound lens combined in the pyroelectric type infrared ray detection element, the individual detection areas for detecting infrared rays through the respective lens portions are dispersed and distributed in an entire detection area in a state spaced from each other in the entire detection area. Therefore, there exist many non-sensing areas, which cannot detect the infrared rays among a plurality of individual detection areas, in the entire detection area. If many non-sensing areas exist in the entire detection area like this, there is a problem that, a human body in the detection area cannot be detected reliably or detection of the human body becomes erratic.

In addition, although there is means for making the optical axes of the lens portion closer to each other in order to reduce the non-sensing areas in the detection area, the detection area of a predetermined width cannot be secured only therewith, wherein the number of lenses of the lens portion is increased, and the design thereof becomes complicated. On the other hand, if the projection magnification of the lens portion is raised, and the individual detection areas adjacent to each other overlap, detection of a human body becomes impossible by means of the pyroelectric type infrared ray detection element for detecting a change in the amount of infrared rays in accordance with movement of the human body.

Further, although, in order to reduce the non-sensing areas in the detection area, it becomes necessary to make the boundaries of the individual detection areas adjacent to each other as close to each other as possible, it is difficult to design the respective lens portions of the compound lens as described above.

The present invention was developed in view of such problems and points, and it is therefore an object of the present invention to provide an infrared ray detector, for which the compound lens can be easily designed, capable of reliably detecting any heat source in a stabilized state, and an electrical apparatus using the infrared ray detector.

### SUMMARY

An infrared ray detector according to the present invention includes a light receiving portion for detecting infrared ray energies and a compound lens having a plurality of lens portions for condensing infrared rays emitted from a predetermined detection area, in which individual detection areas for condensing infrared rays through the respective lens portions exist in the entire range of the predetermined detection area, and at least a part of the respective individual detection areas overlap each other in the predetermined detection area.

With the infrared ray detector, since, by using the light receiving portion for detecting infrared ray energies, the infrared ray energies can be reliably detected by the light receiving portion even if at least a part of the individual detection areas for condensing infrared ray energies through the respective lens portion of a compound lens, with respect to the compound lens, it is not necessary to make the individual detection areas as close to each other as possible so that the boundaries of the individual detection areas do not overlap each other. Also, the compound lens can be easily designed since at least a part of the individual detection areas may overlap each other, and since there is no clearance between the individual detection areas at positions where the individual detection areas overlap, it is possible to reliably detect heat sources in a stabilized state.

In addition, in the present invention and the invention described below, the definition and technical meanings of the terms depend on the following unless otherwise specified.

Infrared ray energy includes, for example, infrared ray energy emitted from a human body being a heat source that is an object whose infrared rays are detected.

The light receiving portion may be equipped with one or a plurality of light receiving elements, which is (are) capable of not detecting a change in the amount of infrared rays but detecting infrared ray energies. For example, a solid-state image pickup element in which light receiving elements such as a plurality of photodiodes are two-dimensionally disposed, such as CMOS and CCD, etc., and a thermoelectric conversion element such as a bolometer and a thermopile, which has characteristics the output current and output voltage of which change by a change in temperature in accordance with infrared ray energies may be used. In addition, a filter that transmits an infrared ray having a desired wavelength to the light receiving side of the light receiving portion and prevents light of wavelengths other than the desired wavelength from being transmitted may be disposed. And, since infrared ray energies can be detected at the light receiving portion, a human body that emits infrared rays can be detected even if the human body stops.

The compound lens is formed of, for example, a material such as polyethylene that transmits infrared rays, and is provided with a plurality of lens portions along a predetermined curvature or plane. For example, a plurality of lens portions are disposed in a plurality concentrically centering around the axis perpendicular to the middle part of the light receiving portion along a semi-spherical surface formed with a predetermined radius centering around the middle part of the light receiving portion, and the focal distances of all the lens portions to the light receiving portion are made equal to each other. In further detail, four lens portions are disposed on the same circumference at the middle part of the compound lens, twelve lens portions are disposed on the same circumference at the circumferential part thereof, and twelve lens portions are disposed on the same circumference at the extreme circumferential part thereof, whereby individual detection areas for detecting emitted infrared ray energies through the respective lens portions exist in the entire range of a predetermined detection area. However, the lens arrangement is not limited thereto. Also, at least a part of the individual detection areas may overlap each other or all thereof may overlap each other in the predetermined detection area. Where only a part of the individual detection areas overlap each other, non-overlapped portions may exist, wherein there may be clearance among the individual detection areas at the portions. Where there is clearance among the individual detection areas, the clearance portions become non-sensing areas, which do not detect any infrared ray energy emitted therefrom, in the predetermined detection area. However, if the clearance portion is smaller than a human body, the human body can be detected by any other individual detection areas adjacent to the clearance portions. Further, the non-sensing area indicates an area that, in a predetermined detection area, exists among the individual detection areas, is unable to condense the infrared ray energy emitted from a human body in respective individual detection areas to the light receiving portion, and cannot detect the infrared ray energy at the light receiving portion.

Since the light receiving portion detects infrared ray energy, the infrared ray energy can be detected without any influence even if the individual detection areas overlap in a predetermined detection area.

The detection area is a range the diameter of which is approximately 5 meters on a plane approximately 2 meters forward of an infrared ray detector, for example, in a case of detecting a human body. However, the detection area is not limited thereto.

In addition, in the infrared ray detector according to the present invention, the compound lens has no clearance among the respective individual detection areas in the predetermined detection area.

According to the infrared ray detector, since the compound lens does not have any clearance among the respective individual detection areas in the predetermined detection area, it is possible to reliably detect a heat source in a stabilized state in the entire range of the predetermined detection area.

Further, a state where there is no clearance among the individual detection areas includes a case where there is no clearance because the individual detection areas overlap each other and a case where there is no clearance because the boundaries of the individual detection areas are coincident with each other even if they do not overlap each other.

Still further, the infrared ray detector according to the present invention is provided with an adjusting unit for adjusting infrared ray energies incident from the respective lens portions of the compound lens into the light receiving portion.

According to the infrared ray detector, since the infrared ray energy incident from the respective lens portions of the compound lens into the light receiving portion can be adjusted by the adjusting unit for adjusting infrared ray energy, the infrared ray energy incident from the respective lens portions into the light receiving portion can be kept fixed, and detection control of the infrared ray energy can be facilitated.

Also, the adjusting unit is disposed, for example, forward of the compound lens or between the compound lens and the light receiving portion, and the amount of transmission of the infrared ray energy incident from the respective lens portions into the light receiving portion can be adjusted. Further, the amount of transmission of infrared ray energy is adjusted by, for example, the effective area, thickness and surface accuracy of the lens portion per lens portion of the compound lens. Also, for example, where the light receiving portion has light-receiving elements accommodated in a package and seals the elements in a vacuum state, the amount of transmission of infrared ray energy may be adjusted by the thickness and surface accuracy of the infrared ray incidence window secured at the package. Or, the amount of transmission of infrared ray energy may be adjusted by the shape of a getter material utilizing the getter material to increase the vacuum degree by adsorbing gasses in the package.

Furthermore, an electrical apparatus according to the present invention is provided with the infrared ray detector and a control circuit for controlling a load by an infrared ray detection signal being input from the infrared ray detector.

Accordingly, with the electrical apparatus, load can be controlled by using the infrared ray detector.

The electrical apparatus may be, for example, a lighting instrument, air-conditioning equipment, and a security apparatus for a security system, etc., and in line therewith, the control circuit controls a light source, a fan and an alarm device, which is a load thereof.

### BRIEF DESCRIPTION OF THE DRAWINGS

FIG. 1 is a sectional view of an infrared ray detector according to Embodiment 1 of the present invention;

FIG. 2 is a front elevational view of a compound lens of the infrared ray detector;

FIG. 3 is a distribution view of a detection area and individual detection areas of the infrared ray detector;

FIG. 4 is a front elevational view of a light receiving portion of the infrared ray detector;

FIG. 5 is a circuit diagram of lighting equipment using the infrared ray detector;

FIG. 6 is a sectional view of a lighting instrument used in the lighting equipment;

FIG. 7 describes an infrared ray detection operation where the individual detection areas of the infrared ray detector do not overlap each other; wherein (a) is a schematic view of individual detection areas, (b) is a schematic view of the light receiving portion, and (c) is a graph showing the output of the light receiving portion;

FIG. 8 describes an infrared ray detection operation where the individual detection areas of the infrared ray detector overlap each other; wherein (a) is a schematic view of individual detection areas, (b) is a schematic view of the light receiving portion, and (c) is a graph showing the output of the light receiving portion;

FIG. 9 is a distribution view of a detection area and individual detection areas of the infrared ray detector showing Embodiment 2 of the present invention;

FIG. 10 shows an infrared ray detector showing Embodiment 3 of the present invention, wherein (a) is a sectional view of the infrared ray detector, and (b) is a front elevational view of a filter body acting as an adjusting unit; and

FIG. 11 is a sectional view of an infrared ray sensor used in the infrared ray detector showing Embodiment 4 of the present invention.

### DETAILED DESCRIPTION

Hereinafter, a description is given of embodiments of the present invention with reference to the accompanying drawings.

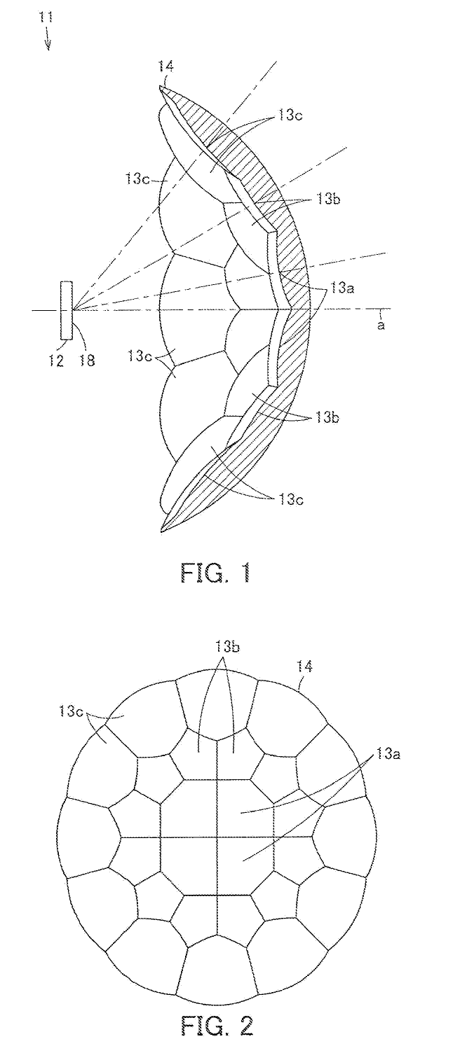

FIG. 1 through FIG. 8 show Embodiment 1.

As shown in FIG. 1, an infrared ray detector 11 is provided with a light receiving portion 12, which detects infrared ray energy emitted from, for example, a human body being a heat source that is an object whose infrared rays are detected, and a compound lens 14 having a plurality of lens portions 13a, 13b and 13c in order to widen a detection area and to efficiently condense the infrared rays to the light receiving portion 12. Further, the infrared ray detector 11 includes a detection circuit for determining detection of infrared ray energy emitted from a human body in order to determine whether a human body exists.

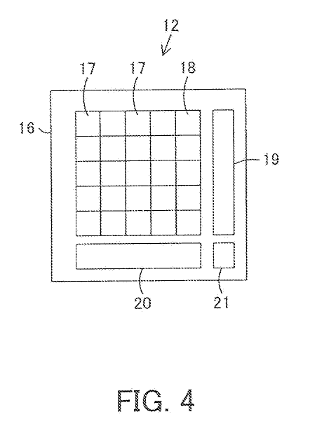

As shown in FIG. 4, the light receiving portion 12 is composed of, for example, a solid-state image pickup element such as a CMOS and CCD, wherein a light receiving plane 18 is formed by two-dimensionally disposing light receiving elements 17 such as a plurality of photodiodes, etc., on a substrate 16. The light receiving plane 18 is formed to be, for example, a square one side of which is approximately 2 millimeters. Also, a horizontal direction register 19 connected to respective light receiving elements 17 in the horizontal direction and a vertical direction register 20 connected to respective light receiving elements 17 in the vertical direction are arranged on the substrate 16, and simultaneously, a reading circuit 21 for reading detection signals by scanning the respective light receiving elements 17 through the registers 19 and 20 is arranged thereon. Also, a filter which transmits an infrared ray of a desired wavelength and prevents infrared rays of wavelengths other than the predetermined wavelength from being transmitted is provided opposite to the light receiving plane 18.

The light receiving portion 12 is accommodated in a metal-made package having an infrared ray incidence window opposed to the light receiving plane 18 and is sealed therein in a vacuum state. Pins for power supply and signal output with respect to the light receiving portion 12 are provided so as to project from the package. Also, the detection circuit is accommodated altogether in the package.

In addition, as shown in FIG. 1 and FIG. 2, the compound lens 14 is integrally formed to be a semi-sphere formed with a predetermined radius centering around the middle part of the light receiving plane 18 of the light receiving portion 12, using, for example, polyethylene resin capable of transmitting infrared rays.

The lens portions 13a, 13b and 13c that the semi-spherical compound lens 14 has are disposed in a plurality in three turns, for example, the middle part, the intermediate part and the circumferential part, three of which are concentric, centering around the axis “a” perpendicular to the middle part of the light-receiving plane 18 of the light receiving portion 12. Further, the lens shapes of the respective lens portions 13a, 13b and 13c are identical to each other, and the focal distances thereof are equal to each other with respect to the middle part of the light receiving plane 18 of the light receiving portion 12. With respect to the effective areas of the respective lens portions 13a, 13b and 13c, the lens portion 13c at the circumferential part has the widest area, and the effective areas thereof become smaller in the order of the lens portion 13a at the middle part and the lens portion 13b at the intermediate part.

The outer surface of the compound lens 14 is formed to be a smooth semi-sphere having a predetermined radius centering around the middle part of the light receiving plane 18 of the light receiving portion 12, and the inner surface thereof is formed to be convex and concave with respect to the respective lens portions 13.

The respective lens portions 13a, 13b and 13c are formed so that the edge parts of the lens portions 13a, 13b and 13c adjacent to each other overlap and cross each other, and the boundaries of the lens portions 13a, 13b and 13c are arranged at the intersections.

A detailed example of the compound lens 14 is such that four lens portions 13a are equidistantly arranged on the same circumference at the middle part of the compound lens 14, twelve lens portions 13b are equidistantly arranged on the same circumference at the intermediate part thereof, and twelve lens portions 13c are equidistantly arranged on the same circumference at the circumferential part. In connection with the inclination angles of the respective lens portions 13a, 13b and 13c with respect to the axis “a” perpendicular to the middle part of the light receiving plane 18 of the light receiving portion 12, the inclination angle of the respective lens portions 13a at the middle part is 14.5°, that of the respective lens portions 13b at the intermediate part is 34°, and that of the lens portions 13c at the circumferential part is 48°. Also, in connection with the effective areas of the respective lens portions 13a, 13b and 13c, the effective area of the respective lens portions 13a at the middle part is 4.9 mm², that of the respective lens portions 13b at the intermediate part is 3.3 mm², and that of the respective' lens portions 13c at the circumferential part is 7.6 mm². The focal distances of the respective lens portions 13a, 13b and 13c are made into 5.6 mm.

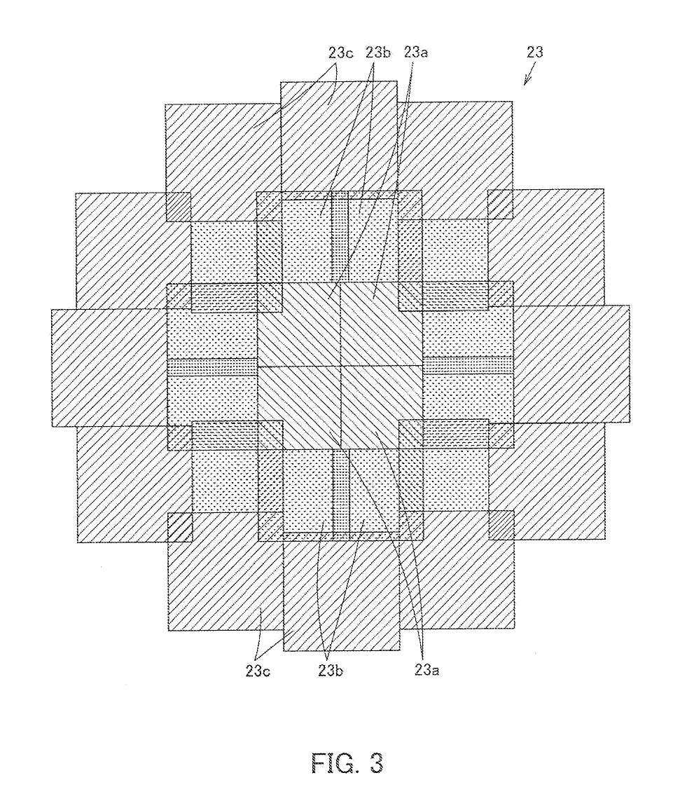

Further, as shown in FIG. 3, a predetermined detection area 23 capable of detecting infrared ray energies by the infrared ray detector 11 is shown. The detection area 23 covers a range the diameter of which is approximately 5 meters on a plane approximately 2 meters forward of the infrared ray detector 11 as a human body sensor.

The detection area 23 is composed of an aggregate of individual detection areas 23a, 23b and 23c being the fields of detection, which detect infrared ray energies through the respective lens portions 13a, 13b and 13c of the compound lens 14. The individual detection areas 23a, 23b and 23c correspond to projection images to which the light receiving plane 18 of the light receiving portion 12 is projected through the respective lens portions 13a, 13b and 13c.

In the present example, the respective individual detection areas 23a, 23b and 23c adjacent to each other are arranged so as to overlap each other without any clearance among the respective individual detection areas 23a, 23b and 23c. Therefore, arrangement of the lens portions 13a, 13b and 13c of the compound lens 14 is such that, in the entire range of the predetermined detection area 23, individual detection areas 23a, 23b and 23c for detecting infrared ray energies emitted from the individual detection areas 23a, 23b and 23c through the respective lens portions 13a, 13b and 13c exist, and there is no non-sensing area where the infrared ray energies emitted from the individual detection area 23 cannot be detected.

And, the infrared ray detector 11 is composed as a single body sensor in which the light receiving portion 12, the compound lens 14 and a detection circuits are integrally incorporated in a sensor case (not illustrated), and is used in a state combined with an electrical apparatus, or is used in a state integrally incorporated in an electrical apparatus.

In addition, in the detection circuit, a threshold value for detecting infrared ray energies emitted from a human body is set in advance between an output value of a light receiving element 17, which detects infrared ray energies emitted from the surroundings, and an output value of the light receiving element 17, which detects only infrared ray energies from a human body. And, it is monitored whether the output values of the respective light receiving elements 17 of the light receiving portion 12 exceed the threshold value, wherein where only one of the light receiving elements 17 exceeds the threshold value, it is detected that a human body exists in the detection area 23, and where all of the light receiving elements 17 become lower than the threshold value, it is detected that a human body moves out of the detection area 23 or any human body does not exist.

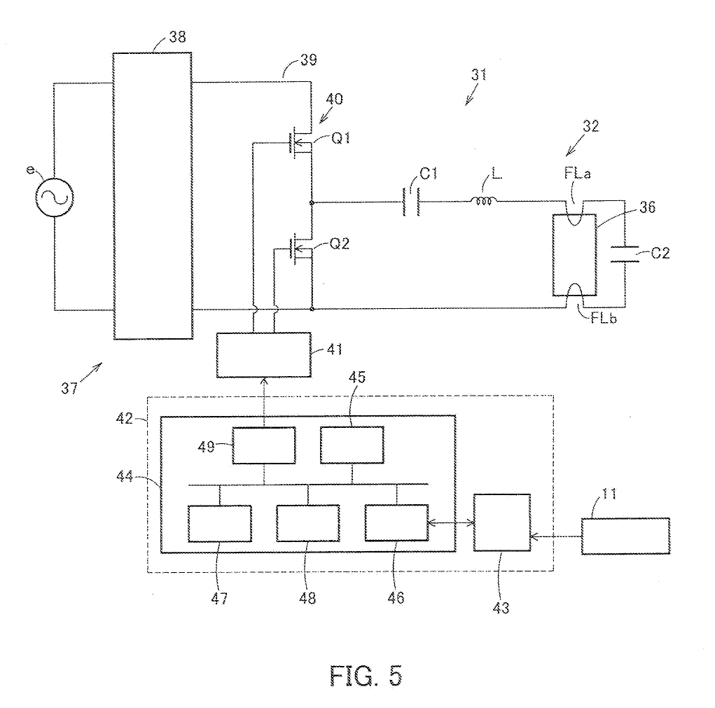

FIG. 5 shows lighting equipment 31 as an electrical apparatus. The lighting equipment 31 is provided with the infrared ray detector 11 and a lighting instrument 32.

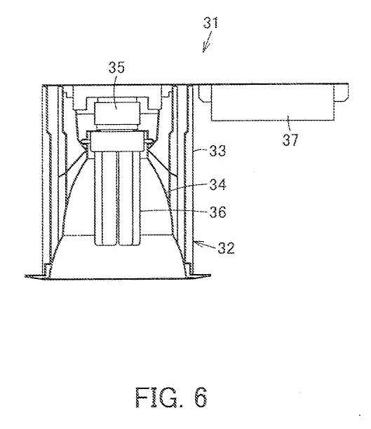

As shown in FIG. 6, the lighting instrument 32 is a downlight installed in a ceiling surface of a corridor, a room, or a floor, and is provided with an instrument body 33 embedded and installed in the ceiling surface, a reflector 34 disposed in the instrument body 33, a socket 35 disposed at the top part side of the reflector 34, a fluorescent lamp 36 mounted in the socket 35, which is a light source and acts as a load, and a lighting control device 37 which controls lighting of the fluorescent lamp 36 in accordance with detection of the infrared ray detector 11 and acts as a load control device. If the infrared ray detector 11 is composed of a single body, the infrared ray detector 11 is installed on the ceiling surface separately from the lighting instrument 32 and if the infrared ray detector 11 is composed to be integral therewith, it is installed in the ceiling surface along with the lighting instrument 32. For example, the infrared ray detector 11 detects a human body in the detection area 23 with the detection direction of infrared ray energies turned downward.

As shown in FIG. 5, in the lighting control device 37 of the lighting equipment 31, a half-bridge type inverter circuit 39 is connected to a rectification filtering portion 38 for rectifying and filtering the commercial alternate current power source “e.” The inverter circuit 39 has FETs Q1 and Q2, which act as a switching element, connected to the rectification filtering portion 38 in series. A capacitor C1 for interrupting a direct current component, resonance winding (resonance inductor) L and a series circuit to filaments FLa and FLb of the fluorescent lamp 36 are connected between both ends of the FET Q2 that become an output end of the inverter circuit 39. A resonance capacitor C2 which functions as a filament preheater is connected between the other ends of the filaments FLa and FLb. As a result, a lighting circuit 40 is composed of commercially available alternate current power source “e,” the rectification filtering portion 38, the inverter circuit 39, the capacitor C1, the resonance winding L and the resonance capacitor C2, etc.

A driver 41 which is a control portion for switching ON and OFF the FETs Q1 and Q2 is connected to a gate being a control terminal of the FETs Q1 and Q2. The operation of the driver 41 is controlled by a lighting control circuit 42 being a load control circuit acting as the control circuit. The lighting control circuit 42 includes an A/D converter 43 connected to the infrared ray detector 11 and a microcomputer 44 being a control unit connected to the A/D converter 43 and the driver 41. The A/D converter 43 analog-digitally converts the signals from the infrared ray detector 11 and outputs the same to the microcomputer 44. Also, the A/D converter 43 may be incorporated in the interior of the microcomputer 44. The microcomputer 44 is provided with a CPU 45 being the central processing unit, an I/O port 46 connected to the A/D converter 43, a ROM 47 to which the CPU 45, etc., refers, a RAM 48 being a memory, and a PWM control portion 49 for controlling the driver 41 with respect to PWM. The ROM 47 stores in advance various types of programs including at least a lighting control program executed by the CPU 45 and an analysis program to analyze data from the infrared ray detector 11. The PWM control portion 49 generates a predetermined high frequency alternate current between the drain and the source of the FET Q2 by alternately turning ON and OFF the FETs Q1 and Q2 by means of the driver 41 at a frequency of several tens of kHz through 200 kHz. Further, the microcomputer 44 of the lighting control circuit 37 is equipped with the function of the detection circuit.

And, in the lighting equipment 31, if no human body exists in the detection area 23 and the lighting control device 37 does not detect any human body by a signal from the infrared ray detector 11, the fluorescent lamp 36 is turned OFF by the lighting control device 37. On the other hand, if a human body exists in the detection area 23 and the lighting control device 37 detects a human body by a signal from the infrared ray detector 11, the fluorescent lamp 36 is turned ON by the lighting control device 37. That is, where the commercially available alternate current power source “e” is rectified and filtered by the rectification filtering circuit 38, a PWM signal generated by the PWM control portion 49 of the lighting control circuit 42 is supplied to the driver 41, and the FETs Q1 and Q2 are alternately turned ON and OFF, a high frequency alternate current is generated between the drain and the source of the FET Q2, preheating control and start voltage application control of the filaments FLa and FLb of the fluorescent lamp 36 are carried out by the resonance winding L and the resonance capacitor C2, wherein the fluorescent lamp 36 is lit.

In addition, in the infrared ray detector 11, where a human body exists in the detection area 23, infrared ray energies emitted from the human body are condensed to the light receiving plane of the light receiving portion 12 and are imaged by the respective lens portions 13a, 13b and 13c of the compound lens 14.

A detection signal responsive to incidence of infrared ray energies onto the light receiving plane 18 of the light receiving portion 12 is output from the light receiving portion 12. Since the light receiving portion 12 detects infrared ray energies, a human body can be detected even if the human body stops and does not make any motion.

Next, a description is given of a detection principle of a desired heat source, for example, a human body by the infrared ray detector 11.

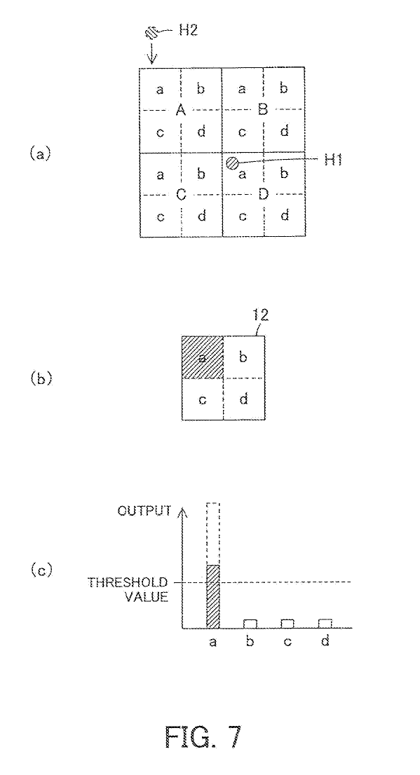

FIG. 7 describes an operation for detecting an infrared ray where the individual detection areas of the infrared ray detector do not overlap each other, wherein (a) is a schematic view of the individual detection areas, (b) is a schematic view of the light receiving portion, and (c) is a graph showing output of the light receiving portion.

In the description, as shown in FIG. 7(b), it is assumed that four light receiving elements “a,” “b,” “c” and “d” of the light receiving portion 12 are provided. Also, as shown in FIG. 7(a), it is assumed that four individual detection areas “A,” “B,” “C” and “D” for detecting infrared ray energies through, for example, the respective four lens portions of the compound lens 14 are provided. Although the boundaries of the individual detection areas “A,” “B,” “C” and “D” are made coincident with each other and have no clearance, the boundaries thereof do not overlap each other. Also, in the respective individual detection areas “A,” “B,” “C” and “D,” areas “a,” “b,” “c” and “d,” which condense infrared rays, are provided, corresponding to the light receiving elements “a,” “b,” “c” and “d” of the light receiving portion 12.

And, as shown in FIG. 7(a), for example, if a human body H1 exists in an area “a” corresponding to one individual detection area D, an infrared ray emitted from the human body H1 is condensed to one light receiving element “a” of the light receiving portion 12 by the lens portion of the compound lens 14 as shown in FIG. 7(b).

Therefore, as the outputs of the light receiving elements “a,” “b,” “c” and “d” are shown in FIG. 7(c), although the outputs of the light receiving elements “b,” “c” and “d” are small since the light receiving elements “b,” “c” and “d” detect only the infrared ray energies in the surroundings, the output of the light receiving element “a” becomes large because the light receiving element “a” detects the infrared ray energy from the human body.

In the detection circuit, it is monitored whether the output values of the light receiving elements “a,” “b,” “c” and “d” exceed the above-described threshold value, wherein although the output values of the light receiving elements “b,” “c” and “d” which have detected only the infrared ray energies from the surroundings do not exceed the threshold value, the output value of the light receiving element “a” that has detected the infrared ray energies from the human body H1 exceeds the threshold value. Therefore, it can be detected that the human body H1 exists in the detection area 23.

Here, if the human body H1 moves out of the detection area 23, the infrared ray energies emitted from the human body H1 are not condensed to the light receiving element “a,” and the output value of the light receiving element “a” becomes lower than the threshold value, wherein it can be detected by the detection circuit that the human body H1 does not exist in the detection area 23.

Further, in FIG. 7(a), where another human body H2 enters the area “a” corresponding to the individual detection area A in a state where the human body H1 exists in the detection area 23, the infrared ray from the human body H2 is condensed by the light receiving element “a” of the light receiving portion 12. For this reason, as shown in FIG. 7(c), the output value (shown by a broken line) corresponding to the human boy H2 is added to the output value corresponding to the human body H1 in regard to the output value of the light receiving element “a.” In this case, since the output value of the light receiving element “a” exceeds the threshold value, it can be detected that the human bodies H1 and H2 exist in the detection area 23.

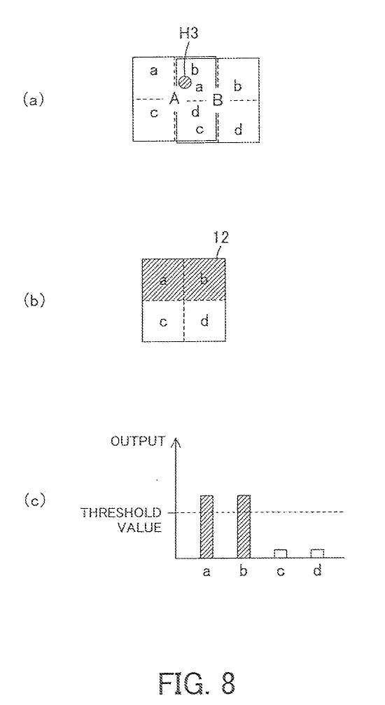

Also, FIG. 8 describes an operation for detection of infrared rays where the individual detection areas of the infrared ray detector overlaps, wherein (a) is a schematic view of individual detection areas, (b) is a schematic view of the light receiving portion, and (c) is a graph showing the outputs of the light receiving portion.

In the description, as shown in FIG. 8(b), it is assumed that four light receiving elements “a,” “b,” “c” and “d” are provided in the light receiving portion 12. Also, as shown in FIG. 8(a), it is assumed that two individual detection areas “A” and “B are provided to detect infrared ray energies through, for example, two respective lens portions of the compound lens 14. Areas “a,” “b,” “c” and “d” to condense infrared rays are provided in the individual detection areas “A” and “B,” corresponding to the light receiving elements “a,” “b,” “c” and “d” of the light receiving portion 12. The areas “b” and “d” corresponding to the individual detection area “A” and the areas “a” and “c” corresponding to the individual detection area “B” overlap each other.

And, as shown in FIG. 8(a), for example, if a human body H3 exists in an area where the area “b” corresponding to the individual detection area “A” and the area “a” corresponding to the individual detection area “B” overlap, infrared rays emitted from the human body H3 are condensed onto two light receiving elements “a” and “b” of the light receiving portion 12 by the lens portion of the compound lens 14 as shown in FIG. 8(b).

Therefore, as shown in FIG. 8(c) with respect to the outputs of the light receiving elements “a,” “b,” “c” and “d,” although the outputs of the light receiving elements “c” and “d” are small since the light receiving elements “c” and “d” detect only the infrared ray energies in the surroundings, the output of the light receiving element “a” and “b” becomes large because the light receiving element “a” and “b” detects the infrared ray energies from the human body.

It is monitored in the detection circuit whether the output values of the light receiving elements “a,” “b,” “c” and “d” exceed the threshold value. Although the output values of the light receiving elements “c” and “d” that have detected only the infrared ray energies in the surroundings do not exceed the threshold value, the output values of the light receiving elements “a” and “b” that have detected the infrared ray energies from the human body H3 exceed the threshold value. Accordingly, it can be detected that the human body H3 exists in the detection area 23.

Therefore, in the configuration of the infrared ray detector 11, even if at least a part of the individual detection areas 23a, 23b and 23c to condense infrared rays through the respective lens portions 13a, 13b and 13c of the compound lens 14 overlap each other, it is possible to reliably detect infrared ray energies at the light receiving portion 12 by using the light receiving portion 12 for detecting infrared ray energies. Accordingly, it is not necessary to design the compound lens 14 so as to approach the boundaries of the individual detection areas 23a, 23b and 23c as closely to each other as possible, the compound lens 14 can be easily designed because at least a part of the individual detection areas 23a, 23b and 23c may overlap each other. Furthermore, since there is no clearance between the individual detection areas at a position where the individual detection areas 23a, 23b and 23c overlap, a heat source can be detected reliably in a stabilized state.

In addition, as shown in FIG. 3, since no clearance is provided among the individual detection areas 23a, 23b and 23c and any non-sensing area unable to detect infrared ray energies is eliminated, it is possible to reliably detect a heat source in a stabilized state in the entire range of the detection area 23.

In particular, since four lens portions 13a are equidistantly arranged on the same circumference at the middle part of the compound lens 14, twelve lens portions 13b are equidistantly arranged on the same circumference at the intermediate part thereof, and twelve lens portions 13c are equidistantly arranged on the same circumference at the circumferential part, the individual detection areas 23a, 23b and 23c for detecting infrared ray energies through the respective lens portions 13a, 13b and 13c are caused to exist in the entire range of a predetermined detection area 23, wherein it becomes easy to eliminate any non-sensing area.

In addition, the lens shapes of the respective lens portions 13a, 13b and 13c of the compound lens 14 are identical to each other, and the focal distances thereof are caused to be equal to each other with respect to the middle part of the light receiving plane 17 of the light receiving portion 12, it becomes easy to design and produce the compound lens 14. Further, since the respective lens portions 13a, 13b and 13c of the compound lens 14 are composed so that the edge parts of the lens portions 13a, 13b and 13c adjacent to each other overlap and cross each other and the boundaries of the lens portions 13a, 13b and 13c are arranged at the intersections thereof, there is no case where any non-sensing area is brought about at the detection areas 23 on the boundaries.

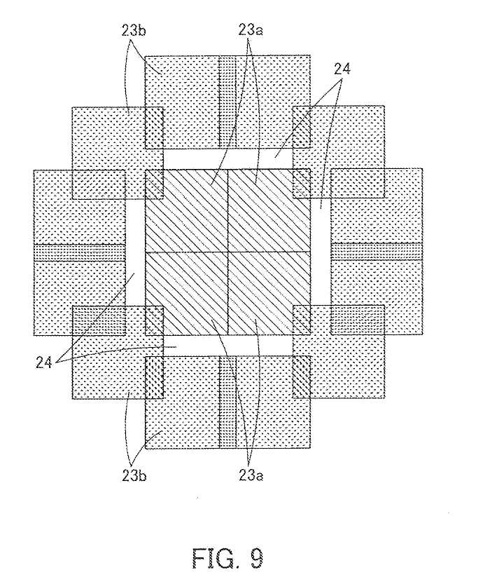

Next, FIG. 9 shows Embodiment 2, which is a distribution view of the detection area and the individual detection areas of the infrared ray detector.

In the detection area 23 shown in FIG. 3, only the respective individual detection areas 23a at the middle part and the respective individual detection areas 23b at the intermediate part are shown. This is a case where there is clearance 24 between the individual detection areas 23a at the middle part and the individual detection areas 23b at the intermediate part. In this case, apart of the individual detection areas 23a at the middle part and the individual detection areas 23b at the intermediate part overlap each other, and simultaneously, part of the individual detection areas 23b adjacent to each other overlap.

Thus, clearance 24 may be acceptable if at least a part of the individual detection areas 23a and 23b overlap each other. In this case, although the clearance 24 becomes a non-sensing area which does not detect any infrared ray energy in the detection area 23, the individual detection areas 23a and 23b adjacent thereto can reliably detect a human body if the human body exists in the clearance 24 if the size of the clearance 24 is smaller than the human body.

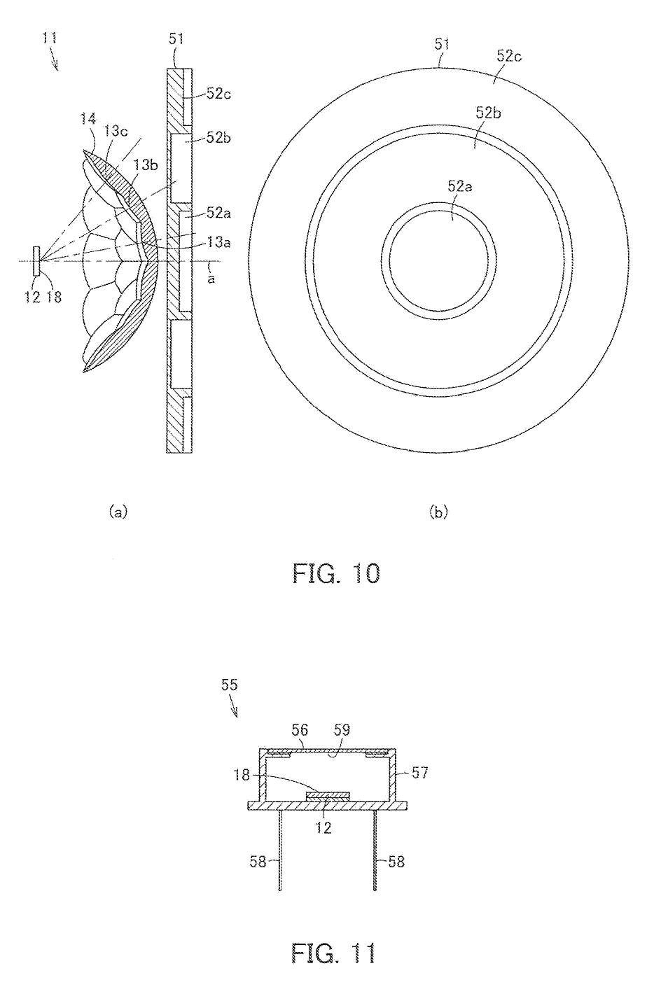

Next, FIG. 10 shows Embodiment 3, wherein FIG. 10(a) is a sectional view of an infrared ray detector, and FIG. 10(b) is a front elevational view of a filter body acting as an adjusting unit.

Since the compound lens 14 has the respective lens portions 13a, 13b and 13c arranged so that no non-sensing area is brought about in the detection area 23, and the effective areas of the respective lens portions 13a, 13b and 13c are different from each other to be 4.9 mm², 3.3 mm², and 7.6 mm², the light condensing amounts of infrared rays accordingly differ, wherein the amounts of infrared ray energies incident into the light receiving portion 12 differ for each of the lens portions 13a, 13b and 13c. If existence of a human body is detected by acquiring a detection output of the light receiving portion 12 by means of a detection circuit in a state where the amounts of infrared ray energies incident into the light receiving portion 12 for each of the lens portions 13a, 13b and 13c are thus different from each other, the detection sensitivity does not become fixed, wherein a problem is caused that the detection algorithm in the detection circuit becomes complicated.

Therefore, a filter body 51 acting as an adjusting unit for adjusting the amounts of infrared ray energies incident from the respective lens portions 13a, 13b and 13c into the light receiving portion 12 so that the amount thereof is fixed is arranged at a position, into which the infrared rays emitted from the interior of the detection area 23 are made incident, forward of the compound lens 14.

The filter body 51 is formed, to be disk-shaped, of a material, through which desired infrared rays can be transmitted, capable of attenuating the amount of transmission of infrared ray energies in accordance with the transmission distance of the infrared rays.

Groove portions 52a, 52b and 52c are concentrically formed at the middle part area through which infrared rays incident into the lens portion 13a at the middle part of the compound lens 14 are transmitted, at the intermediate part area through which infrared rays incident into the lens portion 13b of the intermediate part around the middle part area are transmitted, and at the circumferential part area through which infrared rays incident into the lens portion 13c at the circumferential part around the intermediate part area on the opposite side of the filter body 51 with respect to the compound lens 14, respectively.

The depths of the groove portions 52a, 52b and 52c are the shallowest at the circumferential part area and become deeper in the order of the middle part area and the intermediate part area so that the amount of transmission of infrared ray energies of the filter body 51 are the least at the circumferential part area and are increased in the order of the middle part area and the intermediate part area in accordance with the effective area of the respective lens portions 13a, 13b and 13c, that is, the light condensing amount of infrared rays. In other words, the filter body 51 is the thickest at the circumferential part area and becomes thinner in the order of the middle part area and the intermediate part area.

Therefore, since the amounts of infrared ray energies incident from the respective lens portions 13a, 13b and 13c into the light receiving portion 12 can be fixed by the filter body 51, the detection sensitivity becomes fixed, and it becomes possible to simplify the detection algorithm in the detection circuit.

Also, such a filter body 51 may be disposed between the compound lens 14 and the light receiving portion 12.

Further, the compound lens 14 may be provided with the function of the adjusting unit.

As one example, the lens thickness is made thinner in the order of the circumferential part, the middle part and the intermediate part so that the amount of transmission of infrared ray energies is increased in the order of the circumferential part, the middle part and the intermediate part in accordance with the effective area becoming smaller in the order of the circumferential part, the middle part and the intermediate part in the lens portions 13a, 13b and 13c of the compound lens 14. The amounts of infrared ray energies incident from the respective lens portions 13a, 13b and 13c into the light receiving portion 12 can be fixed by the compound lens 14.

As another example, surface processing such as roughing to reduce the amount of transmission of infrared ray energies is carried out on the outer surface or the inner surface of the compound lens 14 so that the amount of transmission of infrared ray energies is increased in the order of the circumferential part the middle part and the intermediate part in accordance with the effective area becoming smaller in the order of the circumferential part, the middle part and the intermediate part in the lens portions 13a, 13b and 13c of the compound lens 14. The amounts of infrared ray energies incident from the respective lens portions 13a, 13b and 13c into the light receiving portion 12 can be fixed by the compound lens 14.

As still another example, by thickening the thickness of the lens portion 13b at the intermediate part of the compound lens 14, the effective area of the lens portion 13b at the intermediate part is increased, and the effective areas of the lens portions 13c and 13a at the circumferential part and the middle part are decreased, and the lens portions 13a, 13b and 13c are balanced, whereby the amounts of infrared ray energies incident from the respective lens portions 13a, 13b and 13c into the light receiving portion 12 can be fixed.

Next, FIG. 11 shows Embodiment 4, which is a sectional view of an infrared ray sensor portion used for the infrared ray detector.

An infrared ray sensor portion 55 used for the infrared ray detector 11 is accommodated in a metal-made package 57, in which the light receiving portion 12 has an infrared ray incidence window 56 opposed to the light receiving plane 17, and is sealed in a vacuum state. Pins 58 for power supply and signal output project from the package 57.

And, the amount of transmission of infrared ray energies which transmit toward the respective lens portions 13a, 13b and 13c is adjusted by changing the thickness of and giving surface processing to the infrared ray incidence window 56 as the adjusting unit as described above, wherein the amounts of infrared ray energies incident from the respective lens portions 13a, 13b and 13c into the light receiving portion 12 can be fixed.

Further, where a getter material 59 to increase the vacuum degree by adsorbing gases in the package 57 is provided in the package 57, the getter material 59 is used as the adjusting unit, and the amount of transmission of infrared ray energies may be adjusted. For example, the getter material 59 is formed to be like a thin film on the inner surface of the infrared ray incidence window 56, and the amount of transmission of infrared ray energies transmitted toward the respective lens portions 13a, 13b and 13c is adjusted, wherein the amounts of infrared ray energies incident from the respective lens portions 13a, 13b and 13c into the light receiving portion 12 can be fixed.

In addition, the infrared ray detector 11 may be used not only for a human body detector but also for flame detection in a fire alarm apparatus.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An infrared ray detector, comprising:
a light receiving portion for detecting infrared ray energies; and
a compound lens having a plurality of lens portions for condensing infrared rays emitted from a predetermined detection area, in which individual detection areas for condensing infrared rays through the respective lens portions exist in the entire range of the predetermined detection area, and at least apart of the respective individual detect ion areas overlap each other in the predetermined detection area.

2. The infrared ray detector according to claim 1, wherein the compound lens has no clearance among the respective individual detection areas in the predetermined detection area.

3. The infrared ray detector according to claim 1 further comprising an adjusting unit for adjusting infrared ray energies incident from the respective lens portions of the compound lens into the light receiving portion.

4. An electrical apparatus comprising:
an infrared ray detector according to claim 1; and
a control circuit for controlling a load by an infrared ray detection signal being input from the infrared ray detector.
